(19) United States
(12) Patent Application Publication
(10) Pub. No.: US 2024/0220951 A1
(43) Pub. Date: Jul. 4, 2024

(54) CONFIGURING AND TRIGGERING NOTIFICATION ACROSS A COMPUTER NETWORK

(71) Applicant: Truist Bank, Charlotte, NC (US)

(72) Inventor: Barath Jayaraman, Fort Mill, SC (US)

(73) Assignee: Truist Bank, Charlotte, NC (US)

(21) Appl. No.: 18/149,486

(22) Filed: Jan. 3, 2023

(51) Int. Cl. G06Q 20/10; G06Q 20/40

(52) U.S. Cl. CPC G06Q 20/108; G06Q 20/407

(57) ABSTRACT

A method and system for enabling a user to receive status messages related to an item on a list. The system includes a user computing device in communication with a server computer across a network. The user views a list and identifies any items for which the user wishes to receive the status messages. The user confirms configuration settings for the status messages, including the type and timing of status messages to receive and the form of notification to be used for the status messages. Types of status messages include a pending status, which is sent to the user after a first time period, an overdue status, which is sent to the user after a second time period, and a resolved status, which is sent to the user when the event occurs. Forms of notification include pop-up messages in the system, push notifications, emails and text messages.

### FIELD

The present disclosure relates generally to the field of digital banking systems, and more particularly to a method and system for enabling a customer to receive alerts related to refunds that the customer is due to receive, where the alerts can be provided in the form of push notifications or messages in the digital banking system, and the alerts can advise of a pending refund, a delayed refund requiring customer action, and a received refund.

### BACKGROUND

Digital banking systems are well known and used by many bank businesses and their customers. Two common types of digital banking systems are online web-based systems which interact with a user via a web browser window on a computer, and mobile applications (“apps”) which run on mobile devices such as smart phones and tablets. Both online web-based banking systems and mobile banking apps communicate with back-end servers which validate and execute specific transactions, provide data for display, etc. Both web-based and mobile app-based systems also include security and customer authentication features, where user-provided information and/or biometric information is collected from the customer and validated with data stored on the back-end server. Digital banking systems, including web-based and mobile app-based systems, are often referred to as online banking systems, which terms will be used interchangeably throughout the present disclosure.

Each customer has one or more accounts with the bank, which the customer may access and manage. The accounts might include checking and/or savings accounts, credit cards, and possibly investment accounts or others. Customers who use a bank's digital banking systems have access to near-real-time account information, where transactions are posted to the account ledger soon after the transaction's occurrence. For example, a credit card purchase at a merchant will often appear in the online transaction list for the credit card account within minutes of the purchase. This allows savvy online banking customers to regularly review their transaction list (e.g., to spot potential fraud) and also to keep track of their current account balance. These online transaction lists directly access data from a transaction database, and may be updated many times each day.

It is not uncommon for customers to return purchased items, and to request refunds for goods and services for a variety of other reasons. This is especially true in today's digital economy, where many purchases are made online with no ability to physically evaluate the product being purchased. This may result in some customers having many returns and other refunds pending at any given time. Many customers in this situation resort to keeping hand-written notes in order to keep track of all of the refunds they are expecting, the dates they were requested, etc. Manually tracking refund status in this manner is time-consuming and frustrating to customers.

Even if a customer keeps an accurate list of the several refunds which they have pending, the customer must then check on the status of each pending refund periodically—such as by accessing the online banking system and viewing a recent transaction list to see if each of the refunds has been received. This is another tedious and error-prone manual process which is entirely unsatisfactory to most customers.

In view of the circumstances described above, there is a need for an online banking system feature where transactions in online transaction lists may be flagged as pending a refund, and the system provides updates on the refund status.

### BRIEF SUMMARY

The present disclosure describes a method and system for enabling a customer to receive alerts related to refunds that the customer is due to receive. The system includes a user computing device in communication with a server computer across a network. Using a web-based or app-based digital banking system, the customer views an online transaction list for an account and identifies any transactions for which the customer is due a refund. The customer confirms configuration settings for the refund-related alerts, including the type and timing of alerts to receive and the form of notification to be used for the alerts. Types of alerts include refund pending, which is sent to the customer after a first time period, refund overdue, which is sent to the customer after a second time period, and refund received, which is sent to the customer when the event occurs. Forms of notification include pop-up messages in the digital banking systems, push notifications to the customer's mobile device, emails and text messages.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE DRAWINGS

Having thus described embodiments of the invention in general terms, reference will now be made to the accompanying drawings, wherein:

FIG. 1 illustrates an enterprise system, and environment thereof, including a centralized server system, distributed computers and mobile devices, and communication therebetween, according to at least one embodiment of the present disclosure;

FIG. 2 is a mock-up illustration of a display screen of a mobile device running a digital banking application, depicting a transaction list portion of an account page, as known in the art;

FIG. 3 is a mock-up illustration of a digital banking application running in a web browser window on a computer, depicting an interaction with a user defining criteria for receiving refund status alerts for a transaction selected from an online transaction list, according to an embodiment of the present disclosure;

FIGS. 4-6 are mock-up illustrations of display screens of the mobile device of FIG. 2, depicting different examples of refund status alerts which may be displayed to a customer running a digital banking application, according to an embodiment of the present disclosure; and

FIG. 7 is a flowchart diagram of a method for providing refund status alerts to an online banking customer, according to an embodiment of the present disclosure.

### DETAILED DESCRIPTION OF EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

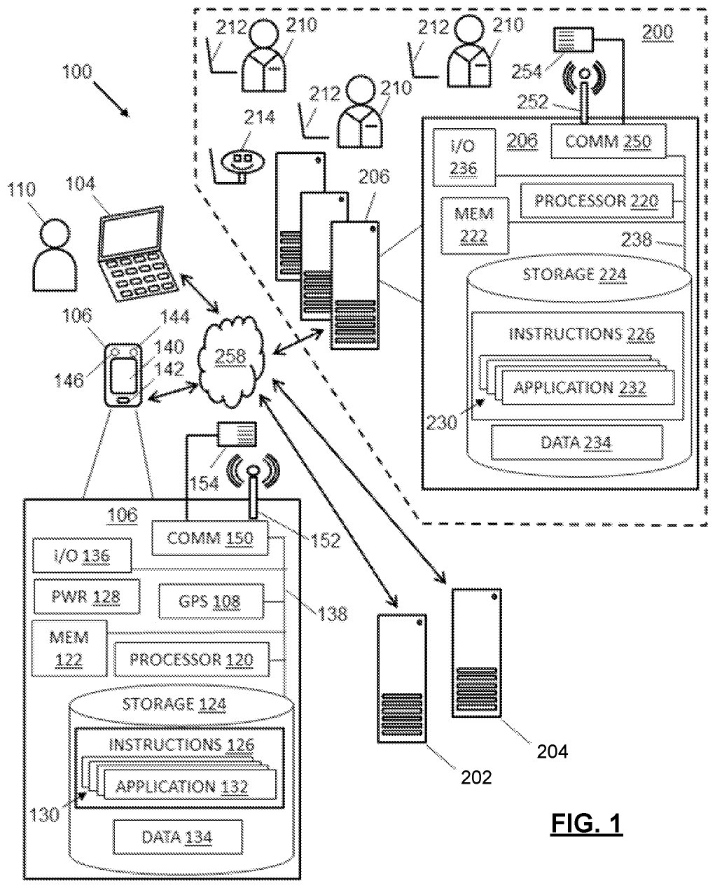

FIG. 1 illustrates a system 100 and environment thereof, including centralized and distributed computing devices, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

One type of algorithm suitable for use in machine learning modules as described herein is an artificial neural network or neural network, taking inspiration from biological neural networks. An artificial neural network can, in a sense, learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, e.g., an acyclic graph with nodes arranged in layers.

Having described an enterprise computing environment as might be used by a banking business, and general characteristics of systems which may be employed in the enterprise computing environment, attention is now turned to the topic of providing proactive refund status alerts in connection with digital banking.

Digital banking systems are well known and used by many bank businesses and their customers, including online web-based systems which interact with a user via a web browser window, and mobile applications (“apps”) which run on mobile devices such as tablets and smart phones. Both online web-based banking systems and mobile banking apps communicate with back-end servers which validate and execute specific transactions, provide data for display, etc.

Banking customers have at least one account, and often more than one account with a bank business. These accounts may include savings accounts, checking accounts, credit cards, etc. Online banking systems provide customers with access to near-real-time transaction lists for each account, where transactions appear in the online system as soon as they are posted to the bank's back end database; these will be referred to herein as online transaction lists.

Customers sometimes have a need to return purchased items or request a refund for purchased goods or services for some reason. The manner in which the customer requests the refund is not relevant to the techniques of the present disclosure. The refund request could be made in writing, by talking to a customer service person on the phone, by returning an item in person at a merchant, or via an online return/refund request from an online retailer.

After requesting a refund, the customer naturally wants to ensure that he or she actually receives the refund. Most refunds are provided by crediting the refund amount (the entire purchase amount or a portion of it) to the original source of payment—such as a credit card or a debit card. Presently, the customer must therefore periodically check the online transaction list for the credit card or debit card account, or check the next statement, to see if the refund has been received.

Using the techniques of the present disclosure, online banking customers can request status alerts in connection with any refund that the customer is expecting to receive. The customer selects a transaction from an online transaction list and indicates the amount of refund due on the transaction. The customer then confirms configuration settings for the refund-related alerts, including the type and timing of alerts to receive and the form of notification to be used for the alerts. Types of alerts include refund pending, which is sent to the customer after a first time period, refund overdue, which is sent to the customer after a second time period, and refund received, which is sent to the customer when the event occurs. Forms of notification include pop-up messages in the digital banking systems, push notifications to the customer's mobile device, emails and text messages. Details of the disclosed techniques are discussed below.

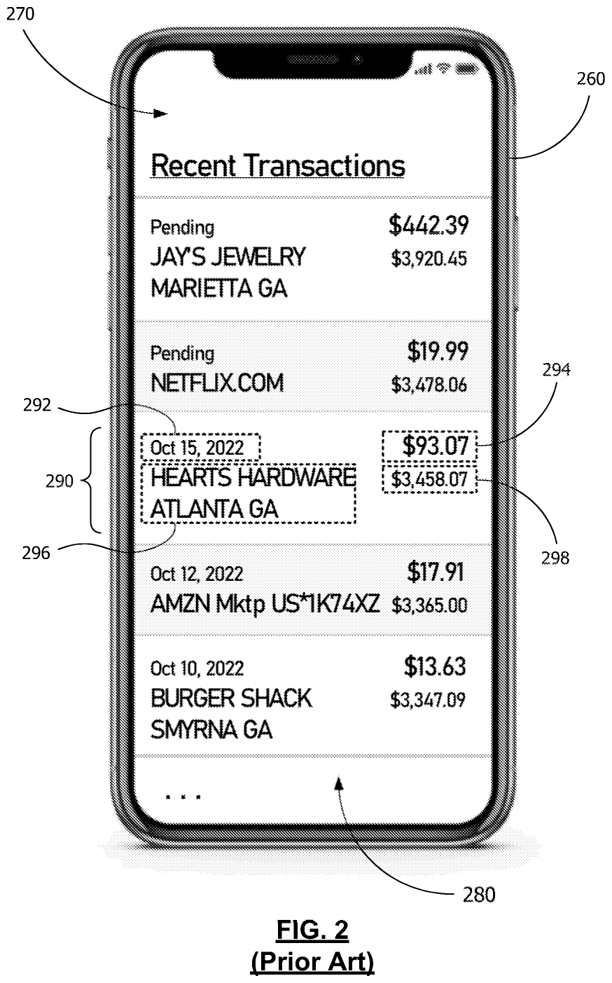

FIG. 2 is a mock-up illustration of a mobile device 260 running a digital banking application, depicting a transaction list portion of an account page, as known in the art. The mobile device 260 of FIG. 2 corresponds with the device 106 of FIG. 1, and it is to be understood that the mobile device 300 communicates with a back-end server such as the computing system 206 of FIG. 1, by way of communications channels such as WiFi and/or cellular communication networks as illustrated by the network 258 (“the cloud”) of FIG. 1.

The mobile device 260 has a display screen 270 which serves as an input/output (I/O) device and user interface for user interaction with applications (apps) which run on the device 260. In FIG. 2, a simplified mock-up of a digital banking app is shown. On the screen depicted in FIG. 2, a transaction list 280 is displayed. These are recent transactions which have been performed in an account that is currently being viewed in the digital banking app. The transaction list 280 shows five transactions, although many more transactions would typically be available for viewing. The customer can scroll up or down to view other transactions, as indicated by the ellipsis.

The transaction list 280 shown in FIG. 2 is illustrated as being displayed on a mobile device, particularly a smart phone. However, it is to be understood that the same information could be displayed in a transaction list on a web-based digital banking system, where the customer uses a computer with web browser software and the account information is displayed in a web browser window. The online transaction list 280 as shown in FIG. 2—whether on a computer (web-based) or on a mobile device (app-based)—differs from account statements which are periodically received by customers, in that the online transaction list 280 is update with new information (new transactions, and changes in transaction status) in near real time, whereas statements are documents which are generated on a periodic basis such as once per month. Both statements and online transaction lists draw their information from a master data source—a database of transactions which is managed by the banking business.

One of the transactions on the transaction list 280 is a transaction 290 which is discussed as representative. The transaction 290 includes a date in box 292, which may be a transaction posting date. For very recent transactions which have not been fully completed and validated, the word “Pending” may be displayed instead of a date. A transaction amount (e.g., amount of purchase) is shown in box 294. A transaction description is shown in box 296; this is information about the transaction which typically includes a merchant name and oftentimes a location (e.g., city). A new account balance is shown in box 298; this is the new balance of the account including the transaction amount which appears above it in the box 294. Because the transaction list 280 of FIG. 2 is intended to depict a credit card account, the new account balance gets higher with each new purchase (going up the list).

The transaction list 280 may appear differently if viewed in a web-based digital banking system rather than an app-based system. The transaction list 280 may also be formatted differently than shown in FIG. 2, and may include somewhat different data elements, without affecting the following discussion. Again, the transaction list 280 is simply a general illustration of an online transaction list that a customer might view for a credit card account, and is provided as a basis for the later discussion of the techniques of the present disclosure. Other types of accounts—such as a checking/debit account—may be viewed in a similar fashion to the depiction of FIG. 2, with one difference being that in a transaction list for a checking/debit account, the new account balance gets lower with each new purchase.

Online banking customers use features of digital banking systems, such as the transaction list 280 depicted in FIG. 2, to keep track of their spending, monitor for potential fraud, etc. Attaching customer-specified data and actions to individual transactions in account transaction lists is a natural extension to the utility of the transaction lists, providing beneficial functionality to the customer.

In the case of the present disclosure, the action that is attached to a transaction is the sending of refund status alerts upon the occurrence of certain triggers. Online banking customers are already familiar with the content and format of the transaction data which is available in transaction lists such as the transaction list 280 of FIG. 2, which makes it a simple matter for a customer to set up refund status alerts as outline below.

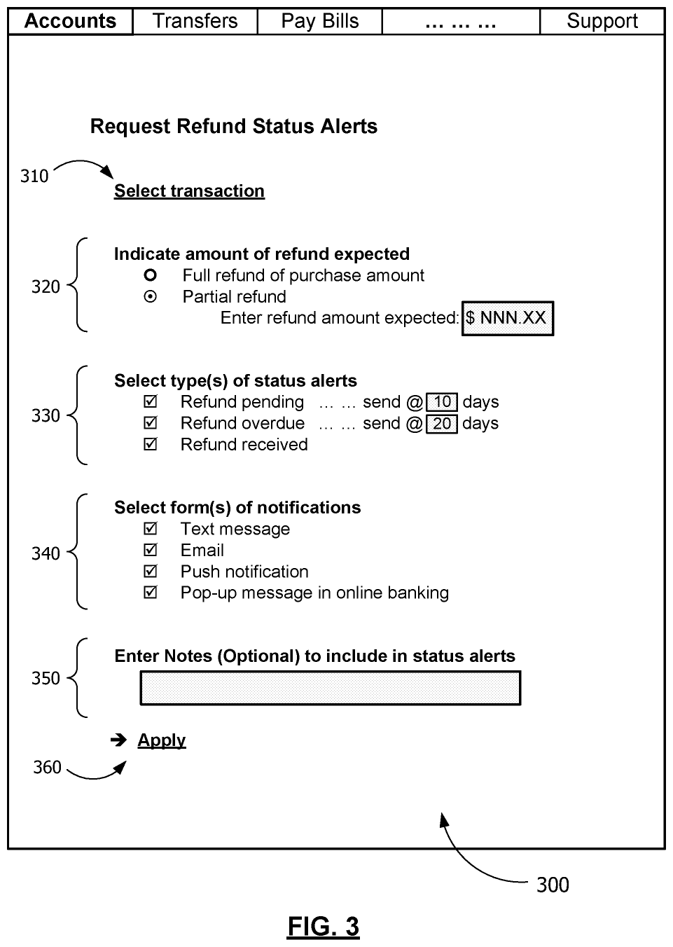

FIG. 3 is a mock-up illustration of a digital banking application running in a web browser window on a computer, depicting an interaction with a user defining criteria for receiving refund status alerts for a transaction selected from an online transaction list, according to an embodiment of the present disclosure.

The computer on which the web browser is running in FIG. 3 corresponds with the computing device 104 of FIG. 1, and is in communication with the computing system 206 (the enterprise server). A web page 300 depicts one embodiment of a user interaction dialog, which will be explained below in detail. It is to be understood that the selections and prompts could be worded differently, or ordered differently on the page 300, without affecting the scope of the technique.

It is also to be understood that a similar set of selections and prompts—for a user to define criteria for receiving refund status alerts—would be available in a mobile banking app (accessed on a smart phone as in FIG. 2, for example). In the case of a mobile app, rather than displaying all of the selections and prompts on a single page as on the web page 300, a series of screens or pages may be used—such as one screen for selecting transactions, another screen for selecting the type of alerts, etc. Again, these implementation details are merely matters of user interface design, and do not affect the scope of the presently disclosed methods.

At the top of the web page 300 is a set of “tabs” (Accounts, Transfers, Pay Bills, etc.) as commonly used in web application design. In the scenario of FIG. 3, the user (customer) has of course logged into the online banking system, and then selected the Accounts tab. The user would then have selected one particular account, and then clicked on an option or command for setting up refund status alerts on a transaction, leading to the web page 300 as shown on FIG. 3.

The various descriptions, options, selections and prompts on the web page 300 follow a standard web application protocol—including the use of radio buttons, checkboxes and underlined selectable items. According to recognized protocols, radio buttons allow only one item from a list to be selected, and if the radio button for one item is selected, all other radio buttons at that list level will be unselected. Checkboxes are used where more than one item may be selected, in a known fashion. Underlined text indicates a clickable selection that may be made by the user, which may take the user to a different page to provide more input (selecting items from a list, for example). Also on the web page 300, boxes with a gray background are used to indicate where the user can enter text and numbers.

The user begins, as indicated by arrow 310, by selecting a transaction for which the user has requested a refund and wants to receive refund status alerts. When the user clicks on Select Transaction, the online transaction list for the appropriate account will be displayed, upon which the user can scroll as necessary to find and select the transaction which is due a refund.

In a section 320, the user indicates the amount of the refund which is expected. The section 320 provides radio buttons, where the user can either select full refund or partial refund. If full refund is selected, no further information is needed in the section 320, and the system will record that a refund of the full amount of the transaction is expected by the user/customer. If partial refund is selected, the user is required to enter the amount of the refund that the user is expecting. For example, if the transaction is for a meal for two people, and the customer calls the restaurant the next day to explain that one of the diners got sick from the food, the restaurant might agree to refund half of the purchase amount. Thus, if the entire transaction was in the amount of $110, the user would enter an expected refund amount of $55.

In a section 330, the user selects one or more types of status alerts which he or she wishes to receive from the online banking system. A first type of status alert is a “refund pending” alert which is sent to the user as a status update, indicating that the refund has not yet been received (as an electronic transaction by the bank), and that the online banking system is still tracking the refund and will send further updates as requested by the customer. If the refund pending alert is selected, the user can then define the number of days (after the refund status alert is requested in the system) at which the system should send the alert. A default value (such as 10 days) is preferably provided in the box, which the user can overwrite if so desired.

A second type of status alert is a “refund overdue” alert which is sent to the user to indicate that the refund has not yet been received, and that the refund is now considered overdue. If the refund overdue alert is selected, the user can define the number of days at which the system should send the alert, with a default value such as 20 days provided. Some actions may be associated with the refund overdue alert, as discussed further below. A third type of status alert is a “refund received” alert which is sent to inform the user that the refund has yet been received by the bank. The refund received alert is triggered by the actual receipt of the refund as an electronic transaction by the bank; thus, there is no need for the user to specify when to send this alert.

The user may select any or all of the three types of status alerts in the section 330, as indicated by the use of checkboxes. In some embodiments of the disclosed system, other types of status alerts may be offered to the user.

In a section 340, the user selects one or more forms of status alert notification which he or she wishes to receive from the online banking system. Available forms of notification include text message, email, push notification (where mobile banking app users have a notification appear on their mobile device home screen or lock screen) and pop-up message (where messages pop up within the web-based or app-based online banking system). These types of notifications would be familiar to most users. The user may select any or all of the four forms of notification in the section 340, as indicated by the use of checkboxes. In some embodiments of the disclosed system, other forms of status alert notification may be offered to the user.

All of the configuration options in the sections 320-340 are preferably pre-set with default values—including system-provided default values, user-specified default values, or last-used values by the user—so that the sections 320-340 can often be completed with little or no input from the user.

In a section 350, the user enters any notes which the user wishes to have associated with this particular refund request. For example, the user may wish to note that the refund was discussed on the phone and agreed to by a customer service associate named James. By including note such as this in the refund status alert system, the user is alleviated of the need to keep written documentation related to the refund request. Providing notes in the section 350 is optional.

After defining all of the refund status alert configuration options in the sections 320-350, the user clicks on “Apply” at 360 to cause the refund status alert data and attributes to be written to a database used by the online banking system. These refund status alert attributes are related to the specific transaction record in the bank transaction database. The online banking system then uses the refund status alert data and attributes to send the alerts to the user as requested, where the sending of the alerts is triggered by an amount of elapsed time or by the bank receiving the refund from the merchant.

Other features related to refund status alerts—not shown on FIG. 3—may be provided in a straightforward manner that would be understood by those skilled in the art. For example, just as an option or command was available on an account screen for requesting refund status alerts, so too would an option be available for canceling the status alert request. Additionally, when the user requests refund status alerts, the online transaction lists could then include a visual flag which indicates that the particular transaction has a refund request associated with it.

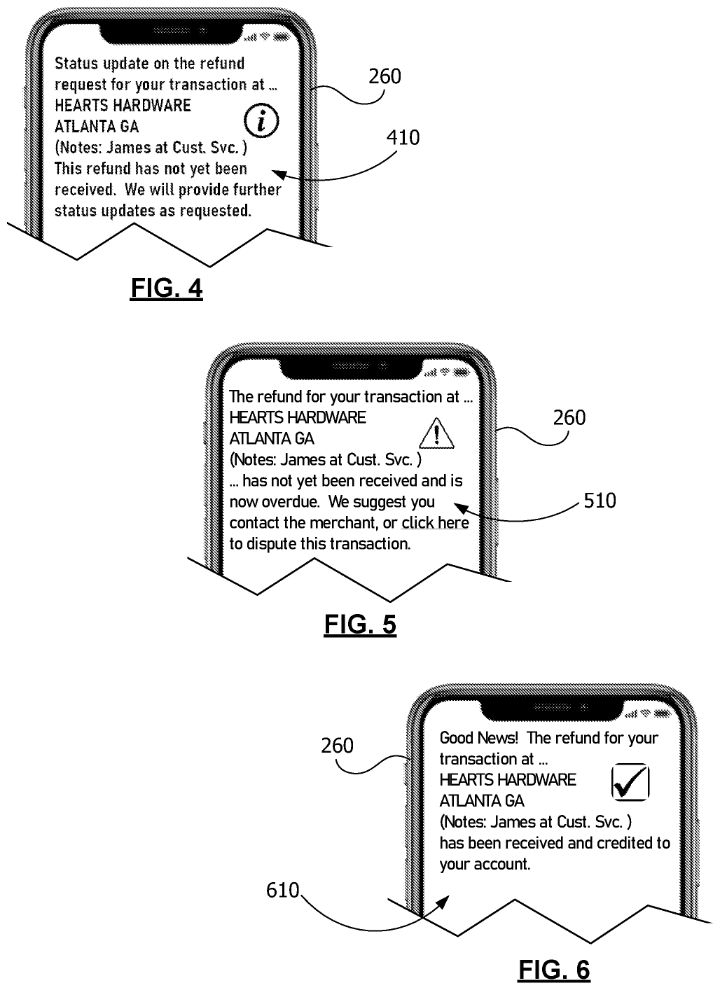

FIGS. 4-6 are mock-up illustrations of display screens of the mobile device 260 of FIG. 2, depicting different examples of refund status alerts which may be displayed to a customer running a digital banking application, according to an embodiment of the present disclosure. In FIGS. 4-6, the user is the same as in FIG. 2, and is running an app-based digital banking system as in FIG. 2. The scenario in FIGS. 4-6 is that the user has requested refund status alerts in connection with the transaction 290 at HEARTS HARDWARE.

In FIG. 4, a refund status alert 410 is provided to the customer as a display element on the mobile device 260, explaining that the requested refund has not yet been received and that further updates will be provided as they become available. The refund status alert 410 is “refund pending” type of status alert, the sending of which was triggered by an amount of time (e.g., 10 days) elapsed since the refund status alert request was created, as explained above in connection with FIG. 3.

In FIG. 5, a refund status alert 510 is provided to the customer as a display element on the mobile device 260, indicating that the requested refund has not yet been received and is now considered to be overdue. Additionally, the refund status alert 510 suggests that the customer contact the merchant regarding the refund, and also provides a clickable link to allow the customer to easily begin the process of disputing the transaction. The refund status alert 510 is “refund overdue” type of status alert, the sending of which was triggered by an amount of time elapsed since the refund status alert request was created, as explained above in connection with FIG. 3.

In FIG. 6, a refund status alert 610 is provided to the customer as a display element on the mobile device 260, indicating that the requested refund has been received and credited to the customer's account. The refund status alert 610 is “refund received” type of status alert, the sending of which was triggered by the refund associated with the specific transaction actually being received by the bank, as explained above in connection with FIG. 3.

The refund status alerts 410/510/610 depicted in FIGS. 4-6 are merely exemplary, and many other graphical and textual forms may be envisioned. Furthermore, content of the refund status alerts 410/510/610 (which are in the form of pop-up messages in the app-based online banking system) may be delivered in the form of text messages, emails and/or push notifications, instead of or in addition to the in-app pop-up messages depicted in FIGS. 4-6. The forms of notification were defined the customer's configuration selections as shown in FIG. 3.

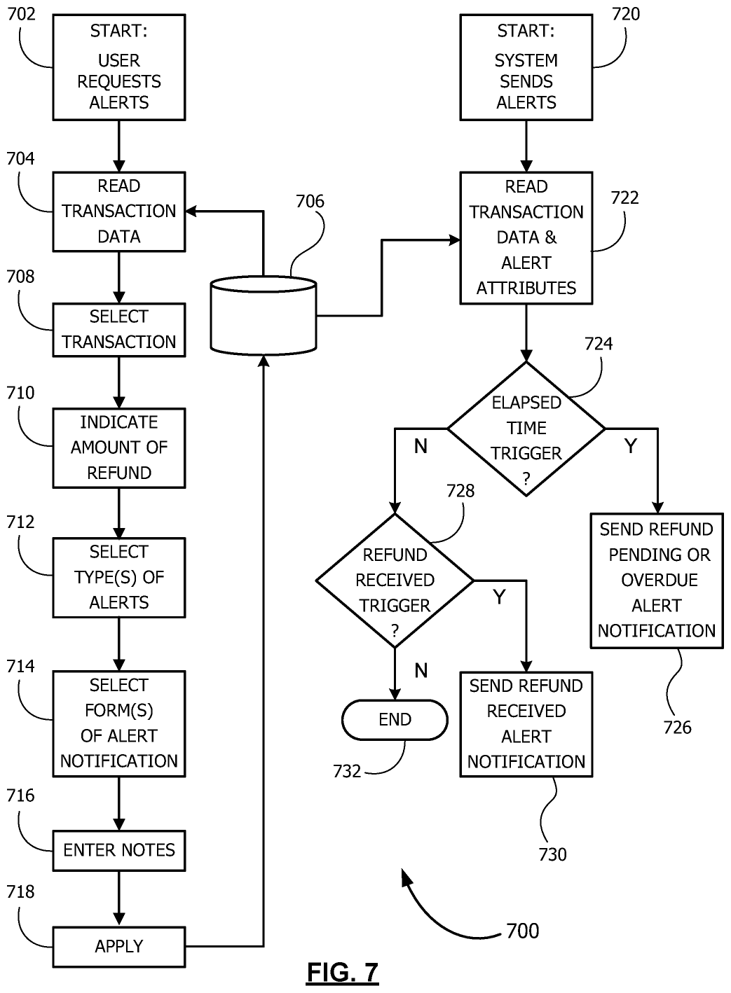

FIG. 7 is a flowchart diagram 700 of a method for providing refund status alerts to an online banking customer, according to an embodiment of the present disclosure. At box 702, the user begins the refund status alert request procedure using the user interface features shown on FIG. 3. At box 704, the system (web-based or app-based digital banking system) reads the account transaction data from a database 706. At box 708, the user selects a transaction for which a refund has been requested.

At box 710, the user indicates whether a refund for the entire amount of the selected transaction is expected. If not, the user enters the amount of the expected refund at the box 710. At box 712, the user selects the type(s) of refund status alerts, including one or more of a refund pending alert, a refund overdue alert and/or a refund received alert. Elapsed time triggers (number of days) are also entered at the box 712 for the refund pending alert and the refund overdue alert, if these types of alerts are selected. At box 714, the user selects the form(s) of refund status alert notifications desired, including one or more of text messages, emails, push notifications and/or pop-up messages in the online banking systems. At box 716, the user optionally enters any notes that are to be displayed along with refund status in the alert notifications. At box 718, the user applies the refund status alert request in the system to put the request into effect. The system then writes the user-specified status alert configuration option attributes to the database 706 where they are stored as data fields related to the specified transaction. The steps taken by the user and the system at the boxes 708 through 718 all correspond directly with the user interface dialog screen depicted on FIG. 3 and discussed earlier.

At box 720, the system begins the refund status alert notification procedure. This initiation at the box 720 may be done several times per day, or on whatever periodic time basis is suitable to the banking business. At box 722, the system reads the transaction data and the status alert configuration option attributes from the database 706. The following steps are performed for each transaction which has an active refund status alert request. At decision diamond 724, it is determined whether an elapsed time trigger has been encountered since the last time the notification procedure was run. Once an elapsed time trigger is encountered (e.g., 10 days for a refund pending alert) and the corresponding alert notification is sent, then this trigger is no longer active. If a time trigger has been encountered at the decision diamond 724, then at box 726 the corresponding refund status alert notification (refund pending or refund overdue) is sent. The refund status alert notification is sent by whatever form(s) of notifications were selected by the user. Examples of refund pending and refund overdue alert notifications in the form of in-app pop-up messages were depicted in FIGS. 4 and 5. Similar information would be sent by other forms of notification (i.e., text message, email, push notification). The alert notifications may include actionable links, such as a link to the corresponding transaction in an online transaction list. The refund overdue alert notification preferably includes a link to an online banking procedure for initiating a dispute of the transaction.

From the decision diamond 724, if an elapsed time trigger was not encountered, then at decision diamond 728 it is determined whether a refund received trigger has been encountered; that is, if a refund was received since the last time the notification procedure was run. If a refund received trigger has been encountered at the decision diamond 728, then at box 730 the corresponding refund received alert notification is sent. The refund received alert notification is sent by whatever form(s) of notifications were selected by the user. An Example of a refund received alert notification in the form of an in-app pop-up message was depicted in FIG. 6. Similar information would be sent by other forms of notification (i.e., text message, email, push notification) if selected by the user. The process ends at terminus 732 if no refund received trigger was encountered, or after sending the refund status alert notification(s) at the box 726 or the box 730.

As mentioned earlier, other steps, not shown on FIG. 7, may be taken in relation to for certain transactions—such as canceling a previously-specified refund status alert request.

The preceding discussion has been structured in terms of a single user and that user's accounts with the bank business. It is to be understood that all of the bank's customers have access to the refund status alert features in the online banking systems, and that the refund status alert attributes are correspondingly stored in relation to the appropriate customer, the specific account of that customer, the specific transactions within that account, etc., in a manner which would be understood by those familiar with transactional database systems.

It is further to be understood that the method of FIG. 7, and the user interface features shown on FIG. 3, are programmed as one or more algorithm which runs on the computing system 206 (the enterprise server) cooperatively and interoperably with the computing device 104 and/or the mobile device 106 (or 260) of the customer. In other words, display and user input steps along with basic process flow steps may be performed in a mobile app in communication with a back-end server which performs other steps and calculations. These devices all include processors, memory and communication modules suitable to run the algorithm and perform the refund status alert request and display in the manner described throughout the present disclosure.

The method and system for refund status alert notification, discussed above, provides features which enable customers to automatically receive updates and reminders related to refunds which they are due. These automated notifications allow customers to forego the tedium of manually tracking refund status, thereby increasing customer satisfaction and encouraging customer usage of web-based or app-based digital banking systems. This increased customer satisfaction in turn leads to further growth of the bank business and its customer base.

Particular embodiments and features of the disclosed methods and systems have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for configuring and triggering a notification across a computer network, said system comprising:
a user computing device comprising at least one processor, a memory, and a communication device; and
a computer with at least one processor, a memory, and a communication device, said computer being in communication with the user computing device,
wherein the user computing device is configured to:
initiate display of a plurality of entries for selection of one or more of the entries by a user;
receive user input through a user input device selecting one or more types of status communication corresponding with the selected entry,
where the one or more types of status communication are selected from a group including status communications which are triggered either by an elapsed time or by an event occurrence;
receive user input through the user input device selecting one or more form of delivery of the status communication for the selected entry;
initiate transmission of the selected one or more types of status communication and one or more form of delivery of the status communication across a communication channel between the user computing device and the computer;
wherein the computer is configured to:
receive transmission from the user computing device and over the communication channel of the transmitted one or more types of status communication and one or more form of delivery of the status communication;
analyze the received transmission to identify information to be stored, including identifying the one or more types of status communication and one or more form of delivery of the status communication as information to be stored;
store the one or more types of status communication and one or more form of delivery of the status communication in a parameter database for quick retrieval in case of occurrence of a triggering event;
access a triggering criteria database to retrieve a triggering criteria comprising one or more predetermined threshold elapsed time or one or more predetermined event characteristic;
monitor whether one of the triggering criteria is met by an actual time exceeding the predetermined threshold elapsed time or an event matching the predetermined event characteristic; and
when the triggering criteria is met, transmit the status communication to the user computing device;
and wherein the user computing device is configured to:
receive the transmission of the status communication from the computer across the communication channel;
in response to receiving the transmission, initiate a notification to the user using an output device, the notification comprising the received status communication.

2. The system according to claim 1 wherein the user computing device is a tablet device or a smart phone configured with a mobile application which communicates with the computer.

3. The system according to claim 1 wherein the user computing device is a computer configured with a web browser application which communicates with the computer.

4. The system according to claim 1 wherein the system is part of a digital banking system in which the user has access to and control of one or more accounts, the selected item is a transaction selected from a transaction list, each transaction includes a transaction description and a transaction amount, and the status communication is a status alert regarding a refund which is due on the transaction.

5. The system according to claim 4 wherein the types of status communication are chosen from a group including a refund pending alert, a refund overdue alert and a refund received alert.

6. The system according to claim 5 wherein the refund pending alert has a triggering criteria of a first elapsed time and the refund overdue alert has a triggering criteria of a second elapsed time which is greater than the first elapsed time.

7. The system according to claim 6 wherein the refund overdue alert includes a link to a feature of the digital banking system where the user can initiate a dispute of the transaction.

8. The system according to claim 7 wherein initiating the dispute of the transaction causes a transaction dispute documentation form to be printed and mailed to the user.

9. The system according to claim 5 wherein the refund received alert has a triggering criteria of the refund being received by a banking business which operates the digital banking system.

10. The system according to claim 4 wherein the forms of delivery of the status communication include text message, email, push notification and pop-up message in the digital banking system.

11. The system according to claim 4 wherein sending one of the types of status communication by the computer includes periodically evaluating each transaction in the transaction list, and sending one of the types of the status communications when a corresponding one of the triggering criteria is met.

12. The system according to claim 4 further comprising defining an amount of the refund which is due on the transaction, by the user.

13. The system according to claim 4 further comprising entering a note to include in the status alert, by the user.

14. A system for triggering a status communication for a transaction, said system comprising:
a user computing device; and
a server computer with at least one processor and memory, said server computer being in communication with the user computing device and with a database containing the transaction list, each transaction on the transaction list including a description field, a value field and other fields related to the transaction,
where the server computer or the user computing device is configured with an algorithm performing steps including;
reading the transaction list from the database;
selecting a transaction from the transaction list, performed by a user using the user computing device;
indicating whether to use a full amount or a partial amount of the value field for the transaction, by the user;
selecting one or more types of status communication for the transaction, by the user, where the one or more types of status communication is chosen from a list including a refund pending alert, a refund overdue alert and a refund received alert, and where the refund pending alert has a triggering criteria of a first elapsed time, the refund overdue alert has a triggering criteria of a second elapsed time which is greater than the first elapsed time, and the refund received alert has a triggering criteria of the refund being received by a banking business which operates the system;
selecting one or more form of delivery of the status communication for the transaction, by the user, where the forms of delivery include text message, email, push notification and pop-up message in the digital banking system;
adding a note to include in the status communication for the transaction, by the user;
writing data defining the status communication for the transaction to the database upon confirmation by the user; and
using the transaction list and the data defining the status communication, by the server computer, to send one of the types of status communication when one of the triggering criteria is met.

15. A method for triggering a status communication for a transaction, said method being executed by a server computer interoperating with a user computing device, said method comprising:
reading a transaction list from a database, by the server computer or the user computing device;
selecting a transaction from the transaction list, performed by the user using the user computing device;
indicating whether to use a full amount or a partial amount of the value field for the transaction, by the user;
selecting one or more types of status communication for the transaction, by the user, where the one or more types of status communication is chosen from a group including status communications which are triggered either by an elapsed time or by an event occurrence;
selecting one or more forms of delivery of the status communication for the selected item, by the user;
writing data defining the status communication for the transaction to the database upon confirmation by the user; and
sending one of the types of status communication, by the server computer, when a triggering criteria, defined by the elapsed time or the event occurrence, is met.

16. The method according to claim 15 wherein the user computing device is a tablet device or a smart phone configured with a mobile application which communicates with the server computer, or the user computing device is a computer configured with a web browser application which communicates with the server computer.

17. The method according to claim 15 wherein the one or more types of status communication include a refund pending alert, a refund overdue alert and a refund received alert, and where the refund pending alert has a triggering criteria of a first elapsed time, the refund overdue alert has a triggering criteria of a second elapsed time which is greater than the first elapsed time, and the refund received alert has a triggering criteria of the refund being received by a banking business which operates the system.

18. The method according to claim 17 further comprising providing, on the refund overdue alert, a link to an application page where the user can initiate a dispute of the transaction.

19. The method according to claim 17 wherein sending one of the types of status communication by the server computer includes periodically evaluating each transaction in the transaction list for which the data defining the status communication is define, and sending one of the types of the status communications when a corresponding one of the triggering criteria is met.

20. The method according to claim 15 wherein the forms of delivery of the status communication include text message, email, push notification and pop-up message in the digital banking system.
